(19) United States
(12) Patent Application Publication
(10) Pub. No.: US 2019/0313666 A1
(43) Pub. Date: Oct. 17, 2019

(54) PET FOOD PRODUCT COMPRISING MICROALGAE AS BINDER

(71) Applicant: MARS, INCORPORATED, McLean, VA (US)

(72) Inventors: Charles Henri Lignet, Aimargues (FR); John Carney, Portland, OR (US)

(73) Assignee: MARS, INCORPORATED, McLean, VA (US)

(21) Appl. No.: 16/474,009

(22) PCT Filed: Dec. 18, 2017
(86) PCT No.: PCT/US2017/066973

§ 371 Date: Jun. 26, 2019

(30) Foreign Application Priority Data
Dec. 29, 2016 (GB) 1622360.4

(51) Int. Cl. A23K 10/16; A23K 10/24; A23K 50/48; A23K 50/42; A23K 50/45; B65B 55/02; B65B 25/00

(52) U.S. Cl. CPC A23K 10/16; A23K 10/24; A23K 50/48; B65B 25/001; A23K 50/45; B65B 55/02; A23K 50/42

(57) ABSTRACT

The use of algal biomass as a binder in reconstituted animal material comprising animal protein is described. The reconstituted animal material is suitable for, or present in, wet pet food products. In particular the use of algal biomass as a partial or full replacement for animal blood plasma binder in reconstituted animal material comprising animal protein is described. The reconstituted animal material is suitable for, or present in, wet pet food products.

The invention relates to the use of algal biomass in pet food products, to the pet food products containing the algal biomass and processes for the preparation of the pet food products.

### BACKGROUND

Pet foods have long been manufactured from animal by-products and non-animal derived ingredients in order to prepare high quality food that provide the pet with the required nutrient profile without competing with the human food demand for meat. As the global population increases the global demand for high protein foods including meat is expected to increase, so an increasing need for pet foods prepared from alternative proteins while meeting the nutritional needs of pets is expected. There is therefore an increasing need for pet foods to be manufactured from more sustainable proteins, in particular for pet foods incorporating a higher amount of non-animal protein while maintaining or improving high levels of nutrition and quality.

Replacing animal proteins with alternative proteins in pet foods requires a number of issues to be addressed, e.g. the products must have integrity (they must not dry out or crumble), they must be palatable to the pet and must have textures and smells that are desirable to both the pet and the pet owner. It is also preferable for new analogue products to be prepared using existing recipes and existing processing assets.

Pet food is commonly categorized on the basis of its moisture content:
(1) Dry or low moisture content products (defined herein as exhibiting less than 15 wt % moisture content). These products typically combine high nutritional content with convenience.
(2) Semi-moist or semi-dry or soft dry or intermediate or medium moisture content products (defined herein as exhibiting from 15 to 50 wt % moisture content).
(3) Wet or high moisture content products (defined herein as exhibiting greater than 50 wt % moisture content). These products are generally most palatable to pets.

### SUMMARY

The present invention is particularly directed towards wet pet food, of which there are two main types.

The first type of wet pet food product is known as ‘pate’ or ‘loaf’ and is typically prepared by processing a mixture of edible components under heat to produce a homogeneous semi-solid mass that is structured by heat-coagulated protein. This homogeneous mass is usually packaged into single serve or multi serve packaging which is then sealed and sterilized. Upon packing, the homogeneous mass assumes the shape of the container.

The second type of wet pet food product is known as ‘chunk-in-gravy’, ‘chunk-in-jelly’ or ‘chunk-in-mousse’, depending on the nature of the sauce component, and these types of products are referred to generically herein as ‘chunk-in-sauce’ products. The present invention is particularly directed to ‘chunk-in-sauce’ wet pet food products. The chunks comprise meat pieces or restructured meat pieces. Restructured meat pieces are typically prepared by making a meat emulsion containing a heat-settable component, and by applying thermal energy to ‘set’ the emulsion and allowing it to assume the desired shape. The product pieces are combined with a sauce (e.g. gravy, jelly or mousse) in single serve or multi serve packaging which is then sealed and sterilized.

Many wet pet food products contain a significant amount of meat and animal by-products. Reconstitution of animal by-products into aesthetically pleasing restructured or reconstituted meat chunks is a key feature of most wet pet food products. A widely used technology relies on the heat setting of meat proteins and the addition of heat-settable binders. Soluble meat proteins coagulate and create a strong matrix when heated above 80° C. Additives such as dried animal blood plasma and other heat setting binders are included to give sufficient chunk strength.

However, blood plasma is an expensive commodity, and it would be desirable to utilise other binders which have a more sustainable and/or flexible and/or economic supply chain.

It would therefore be desirable to provide a replacement for animal blood plasma in reconstituted meat chunks and wet pet food products, particularly wherein the physical characteristics of the reconstituted meat chunks and wet pet food products are maintained or improved. The physical characteristic of the reconstituted meat chunks which is of particular importance is chunk strength or hardness. Cohesiveness or stability of the reconstituted meat chunk is also of importance.

According to a first aspect of the present invention, there is provided the use of algal biomass as a binder in reconstituted animal material comprising animal protein, particularly wherein said reconstituted animal material is suitable for, or present in, wet pet food products. In particular, the present invention provides the use of algal biomass as a partial or full replacement for animal blood plasma binder in reconstituted animal material comprising animal protein, particularly wherein said reconstituted animal material is suitable for, or present in, wet pet food products.

According to a second aspect of the present invention, there is provided a wet pet food product comprising reconstituted animal material, wherein said reconstituted animal material comprises animal protein and a binder, wherein said binder comprises algal biomass.

Unexpectedly, the present inventors have found that algal biomass can be used as a binder to replace animal blood plasma in reconstituted animal material, particularly in wet pet food products.

### DETAILED DESCRIPTION

### Algal Biomass

As used herein, the term “algal biomass” refers to microalgae or the extract thereof (wherein extract of microalgae is referred to herein as “microalgal extract”). Microalgae are single-celled plant organisms. As used herein, the terms “microalgae” and “microalgal extracts” refer to edible microalgae and microalgal extracts, i.e. those that do not cause harm to an animal when ingested. Cultures of microalgae may be obtained from publically available sources, e.g. those available commercially and those that can be obtained by techniques known in the art, e.g. using known culturing methods such as fermentation, photosynthesis, heterotrophy or autotrophy.

The microalgae of particular interest include those rich in one or more polyunsaturated fatty acids (particularly arachidonic acid) such as Rhodophytes (e.g. porphyridium), Chlorophytes (e.g. Chlorella, Haematococcus, Scenedesmus) and Euglenophytes (e.g. Euglena). Preferred algae include those that produce arachidonic acid in the form of a phospholipid or glycolipid, e.g. Rhodophytes, in particular porphyridium. The microalgae is suitably a red microalgae algae. The microalgae is suitably a porphyridium microalgae, preferably porphyridium cruentum.

The algal biomass preferably comprises at least about 25% carbohydrate, preferably at least about 30% carbohydrate. The algal biomass preferably comprises at least about 25% protein, preferably at least about 30%. The stated percentages are the % weight by total weight of the dried biomass.

The microalgae may be microalgae which have been grown in the absence of salt or have been desalted. Suitable methods for desalting are well known in the art and can include, among other techniques, washing (e.g. with water) or filtration (e.g. microfiltration, ultrafiltration or diafiltration).

### The Reconstituted Animal Material

As noted above, the reconstituted animal material comprises animal protein and a binder, wherein the binder comprises algal biomass.

The inventors have unexpectedly found that algal biomass-containing binders are heat-settable. In other words, the binder creates a matrix with meat or animal protein when heated above about 80° C. The matrix is sufficiently strong to create a strong and stable chunk.

The reconstituted animal material preferably comprises from about 0.5 to about 10 wt %, preferably from about 0.5 to about 8 wt %, preferably from about 0.5 to about 5 wt %, preferably at least about 2 wt %, preferably at least about 3 wt %, preferably from about 3 to about 5%, preferably at least about 4 wt % of the binder, by total weight of the reconstituted animal material.

Preferably the binder comprises at least about 5 wt %, preferably at least about 10 wt %, preferably at least about 25 wt %, preferably at least about 30 wt %, preferably at least about 40 wt %, preferably at least about 45 wt % of said algal biomass, by total weight of the binder. The binder may comprise at least 50 wt %, or at least 60 wt %, or at least 75 wt %, or at least 85 wt %, or at least 95 wt % of said algal biomass, or may consist or consist essentially of said algal biomass. Typically, however, the binder also comprises animal blood plasma in combination with said algal biomass. The binder suitably consists or consists essentially of said algal biomass and said animal blood plasma. In a particularly preferred embodiment, the binder comprises from about 30 to about 70 wt % algal biomass (preferably from about 35 to about 65 wt %, preferably from about 40 to about 60, preferably from about 45 to about 55 wt %) and from about 30 to about 70 wt % animal blood plasma (preferably from about 35 to about 65 wt %, preferably from about 40 to about 60, preferably from about 45 to about 55 wt %), by total weight of the binder.

The animal blood plasma is suitably dried animal blood plasma, as conventionally used in the preparation of reconstituted animal material in pet food products. A preferred animal blood plasma is pork plasma.

The reconstituted animal material comprises animal protein. As used herein, the term “animal protein” refers to proteins that originate from vertebrates, such as mammals, fowl and fish. Animal protein may originate, for example, from muscle meat, organs, tendons or bone.

The animal protein in the reconstituted animal material is typically derived from ground animal material, said ground animal material preferably being selected from meat, animal by-products and combinations thereof. The ground animal material may contain at least 50 wt %, or at least 70 wt % or at least 85 wt % of animal by-product. Animal by-products are the entire bodies or parts of bodies of animals or products of animal origin not intended for human consumption; such by-products are conventional in the art for the manufacture of ground animal material suitable for use in pet food products.

Preferably, the reconstituted animal material contains, or is derived from a composition comprising:
(i) binder in an amount from about 0.5 to about 10 wt % by total weight of the reconstituted animal material, as described above;
(ii) ground animal material in an amount of from about 50 to about 99 wt %, preferably from about 60 to about 99 wt %, preferably from about 65 to about 99 wt %, and preferably no more than about 95 wt % or no more than about 90 wt % or no more than about 85 wt %, by total weight of the reconstituted animal material.

The reconstituted animal material, or the composition from which it is derived, may further comprise added water.

The reconstituted animal material may further contain additional ingredients conventionally used in the manufacture of reconstituted meat and wet pet food products, such as fat(s), antioxidant(s), carbohydrate source(s), fiber source(s), additional source(s) of protein (including vegetable protein), seasoning, colorant(s), flavouring(s), mineral(s), preservative(s), vitamin(s), emulsifier(s), farinaceous material(s) and combinations thereof.

The reconstituted animal material may be prepared by an extrusion process at elevated temperature, according to conventional techniques known in the art.

Preferably, the reconstituted animal material is prepared by a process comprising the steps of:
(i) providing ground animal material (which is suitably prepared by grinding pieces of animal material to prepare ground animal material, said animal material being selected from meat, animal by-products and combinations thereof);
(ii) mixing the ground animal material with the heat-settable binder, and optionally additional ingredients, for instance the additional ingredients conventionally used in the manufacture of reconstituted meat and wet pet food products described hereinabove, to prepare a slurry;
(iii) subjecting the slurry to conditions of shear to produce an emulsion; forming a layer of emulsion;
(iv) heating the layer of emulsion to an internal temperature of at least 70° C. (preferably at least about 80° C.); and
(v) cutting or shredding the layer into discrete pieces of reconstituted animal material.

The ingredients may be mixed using any suitable equipment conventional in the art, for instance a heated extruder or a jacketed paddle mixer, optionally combining the ingredients with water.

In the process described above, the slurry preferably comprises from about 50 to about 99 wt % (preferably from about 60 to about 99 wt %, preferably from about 65 to about 99 wt %, and preferably no more than about 95 wt % or no more than about 90 wt % or no more than about 85 wt %) of the ground animal material.

The emulsification of the slurry may be performed in any conventional equipment, for instance a bowl chopper, or meat grinders, including rotating knives and die-plate combinations comprising holes of a defined diameter (for instance from about 0.5 mm to about 10 mm) through which the material passes. Optionally, the resulting material may then be transferred to a mixer where water, dry ingredients (e.g. protein powder of vegetable origin) and liquid ingredients may be added.

The layer of emulsion formed in the process may take the form of, for instance, a sheet, a slab, a ribbon or rope.

In order to activate the heat-settable binder, the emulsion is suitably heated to an internal temperature of at least 70° C., preferably at least 75° C., preferably at least 80° C., and typically no more than about 105° C. The duration of heating is at least 30 seconds, preferably from about 1 to about 60 minutes. The heating of the layer of emulsion is suitably conducted in a steam tunnel.

The layer of emulsion is suitably heated from below by applying steam to the underside of a continuous belt carrying said layer and/or from above by bringing steam into direct contact with the layer of emulsion. Preferably, the emulsion is cooked in a steam tunnel, typically comprising a conveyor system (such as a conveyor belt), which blanches or cooks the emulsion with saturated or super-heated steam injected from above and/or below, thereby exposing the emulsion to a continual and even application of steam to ensure it is cooked thoroughly and set. The emulsion may be in the form of individual chunks during the heating step, but typically cutting into chunks is performed after the heating step.

As used herein, the term “emulsion” refers to a thick mixture of water and other substances derived from raw materials, such as meat or meat by-products. These “emulsions” are dispersions of fat particles and air bubbles in a complex phase composed of water, solubilized meat protein, cellular components and other ingredients. The emulsions may also be referred to as a meat “batter” or a meat “slurry”. Such terms are well understood in the art and are used interchangeably. Typically, the emulsions comprise a continuous phase which is an aqueous medium comprising soluble proteins, soluble muscle constituents, segments of muscle fibers, connective tissue fibers, bones etc., and optionally materials of plant origin materials such as proteins and/or starches and/or fibers and/or minerals, as well as further additives conventional in the art.

Other methods to form the reconstituted animal material include the high moisture extrusion techniques described in WO-00/69276-A. Another suitable process for making the reconstituted animal material is described in U.S. Pat. No. 4,247,562. In general terms, the heated extruder is used to combine ingredients, typically also with water. The mixture is plasticised and heated to form a hot, viscous and at least partly molten mass. The extruder mixes, heats, coagulates, expands and shears the mixture into a meat-like mass which is then extruded and formed into shapes as desired.

A particular advantage of the present invention is the ability to use standard processing and equipment to form the reconstituted animal material.

The total protein content of the reconstituted animal material is preferably in an amount in the range of from about 5 to about 40 wt %, preferably at least about 10 wt %, preferably at least about 15 wt %, and typically no more than about 36 wt %, and preferably from about 25 wt % to about 36 wt %. The protein may comprise animal protein(s), vegetable protein(s) or any combination thereof. The protein fraction of the reconstituted animal material preferably contains at least 50 wt % of animal protein, preferably at least about 60 wt %, preferably at least about 70 wt %, preferably at least about 80 wt %, preferably at least about 90% of animal protein, by total weight of the protein fraction of the reconstituted animal material. Animal proteins include any protein of animal origin (including vertebrate and invertebrate proteins), e.g. proteins derived from mammals, fowl, fish and insects. Examples of suitable animal proteins include those derived from chicken, turkey, beef, lamb, pork, venison, buffalo, duck, kangaroo, shell fish, crustaceans, salmon, tuna, whitefish and the like. They may suitably be derived from muscle meat, organs, tendons, bone etc. Further suitable animal proteins include milk or egg derived proteins. Suitable vegetable proteins include proteins derived from wheat, maize, pea, lupine, potato and the like, for example wheat gluten. The proteins may be in any suitable form, including but not limited to, isolated or partially isolated, concentrated or ground.

The fat content of the reconstituted animal material is preferably less than about 15 wt %, preferably no more than about 13 wt %, preferably no more than about 12 wt %, preferably no more than about 10 wt %, preferably at least about 2 wt %, preferably at least about 4 wt %. The term “fat” as used herein refers to esters of fatty acids such as triglycerides, diglycerides, monoglycerides and phospholipids. The fat preferably contains at least 50 wt %, more preferably at least 70 wt % of triglycerides. The fat may suitably contain animal fat, vegetable oil, marine oil and combinations thereof. Typically, the fat contains at least 10 wt %, more preferably at least 30 wt % and most preferably at least 50 wt % of an animal fat. The animal fat preferably originates from an animal selected from cattle, pigs, sheep, goat, poultry, fish and combinations thereof.

The water content of the reconstituted animal material is typically up to about 75 wt %, or up to about 65 wt %, and typically at least about 20 wt % or at least about 30 wt % or at least about 40 wt % or at least about 50 wt %, and preferably in the range of from about 50 to about 55 wt %, by total weight of the reconstituted animal material.

The fiber and carbohydrate content of the reconstituted animal material is typically up to about 20 wt %, by total weight of the reconstituted animal material. Preferably, the reconstituted animal material comprises no more than about 10 wt % fiber, preferably no more than about 5 wt %, preferably no more than about 2 wt %, typically no more than about 1 wt %, and preferably at least about 0.5 wt %, by total weight of the reconstituted animal material.

The reconstituted animal material typically exhibits a density of from about 0.8 to about 1.2 g/ml.

The size of the reconstituted animal material will vary and depends on the animal that is to consume the pet food and/or the format of the pet food. The longest dimension of the reconstituted animal material is typically from about 5 mm to about 200 mm, preferably at least about 10 mm, preferably no more than about 150 mm. Where the reconstituted animal material is a chunk suitable for a chunk-in-sauce product, as described hereinbelow, the longest dimension is preferably no more than about 50 mm, more preferably no more than about 40 mm, more preferably no more than about 30 mm, and in a preferred embodiment from about 5 mm to 25 mm, preferably from about 13 to about 20 mm.

The reconstituted animal material may also be referred to as a “meat analogue”.

### The Wet Pet Food Product

The term “pet food” as used herein refers to a food composition designed for ingestion by a pet. The wet pet food provided herein is preferably a nutritionally balanced food product to provide a pet with all the essential nutrients it needs in the appropriate quantities.

The pet food may be a pet food providing health and/or nutrition benefits to the pet, e.g. weight management pet foods, satiety pet foods and/or pet foods capable of improving renal function in the pet.

The wet pet food product and the components used therein are selected for consumption by a pet and are not intended for consumption by humans. The term “pet” as used herein preferably refers to a domestic animal, preferably a companion animal, particularly cats or dogs, and in one embodiment cats.

The wet pet food may be a loaf (or pate) product. As noted above, such products are normally in the form of a single piece of reconstituted animal material packaged in a container, such as a can, a pouch or a tray. Typically, these shaped pieces of reconstituted animal material have a piece volume of from about 20 to about 2,000 cm³, more preferably from about 40 to about 1,500 cm³, for instance from about 500 to about 1200 cm³. After packaging and sealing, the aforementioned product is preferably sterilized within the package, e.g. by retort sterilization.

Alternatively, the wet pet food is a chunk-in-sauce product, as described herein above. The term “sauce” as used herein encompasses gravies, jellies and mousses, and preferably refers to a composition in the form of a fluid, a paste, a gel or a mousse. The sauce comprises a liquid carrier, such as water, fats or oils. Preferably the composition is an aqueous composition. A chunks-in-sauce product is prepared by combining the pieces of reconstituted animal material with a sauce, packaging the combination, sealing in the package and sterilizing the package, e.g. by retort sterilization. The pieces of reconstituted animal material may be added to the packaging while the sauce is poured over the pieces, for instance a heated sauce which allows the pieces to warm up and trapped gases to be expelled prior to sealing the packaging. Alternatively, ingredients are added to the reconstituted animal material and packaged, where the ingredients, in the usual sterilisation process, result in the formation in the package of the sauce mixed with the reconstituted animal material.

Sealing of the packaging may be and preferably is conducted using vacuum-sealing.

Retort sterilization is preferably conducted at a retorting temperature in the range from about 115° C. to about 130° C., preferably for approximately 20 to 120 minutes, in order to produce a commercially sterile product.

The packaging may be a can (or tin) or jar (e.g. glass) or otherwise a plastic, metal, foil pouch, or flexifoil.

The wet pet food product may comprise up to 100 wt % of the reconstituted animal material, and preferably at least about 5 wt % of the reconstituted animal material, by total weight of the wet pet food product. In other words, the wet pet food product may comprise, consist essentially or consist of the reconstituted animal material. A loaf product suitably consists essentially or consists of the reconstituted animal material. A chunks-in-sauce product preferably comprises a ratio of reconstituted animal material:sauce of from about 20:80 to about 90:10, preferably at least about 30:70, preferably at least about 40:60, preferably at least about 50:50, preferably at least about 60:40.

The sauce component of the wet pet food product may be any suitable sauce conventional in the art of wet pet food, and typically exhibits a water content of at least about 80 wt %, typically at least about 90 wt %, typically no more than about 98 wt %, by total weight of the sauce. The sauce typically comprises a thickening agent which is used to control its consistency. Thickeners or gelling agents that may be used to prepare the sauce include carrageenan, xanthan, guar gum, cassia gum, starch, gelatine and combinations thereof. The sauce is typically a coating which surrounds the reconstituted animal material.

The sauce may contain additional ingredients conventionally used in the manufacture of wet pet food products, such as fat, antioxidants, carbohydrates, seasoning, colorants, flavouring, minerals, preservatives, vitamins, emulsifiers, farinaceous materials and combinations thereof. The sauce preferably comprises one or more flavouring agents.

Flavourings impart particular taste or smell and may be derived from natural ingredients or artificially created. Flavourings may include one or more products of the Maillard reaction. Flavouring agents such as beef flavour and meat flavour can be used in amounts sufficient to impart the desired flavour.

According to a further aspect of the invention, there is provided a dry or semi-moist pet food product, i.e. a product exhibiting less than 15 wt % moisture or from 15 to 50 wt % respectively, comprising or consisting essentially or consisting of the reconstituted animal material described herein. The reconstituted animal material may also be incorporated into pet food products generally, including supplements, snacks and treats, such as a dry kibble product.

According to a further aspect of the invention, there is provided a process for preparing a reconstituted animal material comprising animal protein and a binder, wherein the binder comprises algal biomass as described herein, and wherein said process comprises preparing said reconstituted animal material by an extrusion process at elevated temperature.

According to a further aspect of the invention, there is provided a process for the preparation of the reconstituted animal material described herein, said process comprising the steps of:
(i) mixing ground animal material with a heat-settable binder comprising algal biomass;
(ii) preferably, preparing a slurry from said mixture and subjecting the slurry to conditions of shear to produce an emulsion of said mixture;
(iii) heating the mixture to an internal temperature of at least 70° C. (preferably at least about 80° C.); and
(vi) forming discrete pieces of reconstituted animal material.

According to a further aspect of the invention, there is provided a process for the preparation of a wet pet food product comprising the reconstituted animal material described herein, said process comprising the steps of:
(i) mixing ground animal material with a heat-settable binder comprising algal biomass;
(ii) preferably, preparing a slurry from said mixture and subjecting the slurry to conditions of shear to produce an emulsion of said mixture;
(iii) heating the mixture to an internal temperature of at least 70° C. (preferably at least about 80° C.);
(vi) forming discrete pieces of reconstituted animal material;

optionally combining said reconstituted animal material with a sauce;
(vi) inserting said reconstituted animal material and optional sauce into packaging; and
(vi) sealing and sterilizing the package to provide a packaged wet pet food product.

According to a further aspect of the invention, there is provided a reconstituted animal material comprising animal protein and a binder, wherein the binder comprises algal biomass as described herein.

The present invention will now be described with reference to the following non-limiting examples.

### EXAMPLES

### Example 1

A series of protein gelling tests was conducted using dried porcine blood plasma (control), freeze-dried porphyridium cruentum algal biomass, and mixtures thereof, in order to compare the gelling properties of the binder and hardness of the resultant materials.

A 5% binder solution was made in deionized water and heated to an initial temperature of 90° C. for 5 minutes, and then cooled at 25° C. overnight. The algal biomass and the porcine blood plasma binders formed stable gels. The algal biomass samples initially formed gels that appeared thicker than the porcine blood plasma samples. Using a 13 mm arch punch, 13 mm chunks of the gels were punch-cut, and the hardness of each chunk was tested under compression with a TA-HDplus® Texture Analyser (Stable Micro Systems).

Surprisingly, the algal biomass-containing gelled samples exhibited hardness which matched or exceeded the porcine blood plasma control. A mixture of 50% algal biomass and 50% porcine blood plasma unexpectedly produced a gelled chunk which exhibited hardness greater than the control, and greater than the 100% algal biomass sample. For the 50:50 gelled chunks (with a mean weight of 0.966 g), the mean hardness was measured at 440 g per gram of chunk.

### Example 2

A series of reconstituted animal material samples comprising animal protein was prepared using the algal biomass and/or porcine blood plasma as the binder (in ratios of 0:100, 25:75, 50:50, 75:25 and 100:0 algal biomass : porcine blood plasma). The animal protein was derived from ground animal material as described herein. The binder comprised 4 wt % of the composition and the ground animal material comprised 96 wt % of the composition. The reconstituted animal material was prepared by a process as described hereinabove, comprising the preparation of a slurry from the mixture of ground animal material and binder. The slurry was subjected to conditions of shear to produce an emulsion, which was then heated to at least 80° C. and then cut to generate discrete pieces of reconstituted animal material. The reconstituted animal material was then combined with a conventional water-based sauce to generate a chunks-in-sauce wet cat food.

The reconstituted animal material comprising algal biomass as binder exhibited a satisfactory hardness which enabled the preparation of wet pet foods therefrom. Thus, the reconstituted animal material was combined with a conventional water-based sauce to generate a chunks-in-sauce wet cat food.

1. A reconstituted animal material comprising animal protein and a binder, wherein the binder comprises algal biomass and animal blood plasma.

2. (canceled)

3. The material of claim 1, wherein the reconstituted animal material is suitable for, or present in, a pet food product, optionally wherein the pet food product is a wet pet food product.

4. The material of claim 1, wherein the algal biomass is edible microalgae or extract of microalgae.

5. The material of claim 4, wherein the microalgae are selected from the group consisting of microalgae that are rich in one or more polyunsaturated fatty acids, optionally arachidonic acid.

6. The material of claim 4, wherein the microalgae are selected from the group consisting of Rhodophytes, Chlorophytes and Euglenophytes, and preferably from the group consisting of porphyridium, Chlorella, Haematococcus, Scenedesmus and Euglena, preferably porphyridium omentum.

7. The material of claim 4, wherein the microalgae are red microalgae.

8. The material of claim 1, wherein the algal biomass comprises at least about 25 wt % carbohydrate and at least about 25 wt % protein, by total weight of dried biomass.

9. The material of claim 1, wherein the algal biomass is desalted algal biomass.

10. The material of claim 1, wherein the binder comprising the algal biomass is heat-settable.

11. The material of claim 1, wherein the reconstituted animal material comprises from about 0.5 to about 10 wt %, preferably from about 0.5 to about 5 wt %, by total weight of the reconstituted animal material.

12. The material of claim 1, wherein the binder comprises at least about 5 wt %, preferably at least about 10 wt %, preferably at least about 25 wt %, preferably at least about 30 wt %, preferably at least about 40 wt %, preferably at least about 45 wt % of the algal biomass, by total weight of the binder.

13. The material of claim 1, wherein the binder comprises at least 50 wt %, at least 60 wt %, at least 75 wt %, at least 85 wt %, or at least 95 wt % of the algal biomass.

14. The material of claim 1, wherein the binder comprises algal biomass and animal blood plasma, or consists or consists essentially of algal biomass and animal blood plasma, preferably wherein the binder comprises from about 30 to about 70 wt % algal biomass and from about 30 to about 70 wt % animal blood plasma by total weight of the binder, preferably wherein the binder comprises from about 45 to about 55 wt % algal biomass and from about 45 to about 55 wt % animal blood plasma by total weight of the binder.

15. The material of claim 1, wherein the animal blood plasma is dried animal blood plasma, preferably porcine blood plasma.

16. The material of claim 1, wherein the reconstituted animal material comprises a composition comprising:
(i) a binder in an amount from about 0.5 to about 10 wt % by total weight of the reconstituted animal material; and
(ii) a ground animal material in an amount of from about 50 to about 99 wt %, by total weight of the reconstituted animal material.

17. The material of claim 1, wherein the reconstituted animal material further contains ingredients selected from the group consisting of fat(s), antioxidant(s), carbohydrate source(s), fiber source(s), additional source(s) of protein, seasoning, colorant(s), flavouring(s), mineral(s), preservative(s), vitamin(s), emulsifier(s), farinaceous material(s) and combinations thereof.

18. The material of claim 1 wherein a total protein content of the reconstituted animal material is in a range of from about 5 to about 40 wt %, preferably from about 25 wt % to about 36 wt %, by total weight of the reconstituted animal material, preferably wherein the protein content of the reconstituted animal material comprises at least 50 wt % of animal protein by total weight of the protein content of the reconstituted animal material.

19. The material of claim 1, wherein the fat content of the reconstituted animal material is less than about 15 wt %, preferably from about 4 wt % to about 13 wt %, preferably wherein the fat content comprises at least 50 wt % of triglycerides by total weight of the fat content.

20. The material of claim 1, wherein the water content of the reconstituted animal material is up to about 75 wt %, and preferably from about 50 to about 55 wt %, by total weight of the reconstituted animal material.

21. The material of claim 1 wherein the reconstituted animal material exhibits a density of from about 0.8 to about 1.2 g/ml.

22. The material of claim 1, wherein the longest dimension of the reconstituted animal material is from about 5 mm to about 150 mm.

23. A pet food product comprising reconstituted animal material, wherein the reconstituted animal material comprises animal protein and a binder comprising algal biomass and animal blood plasma.

24. The pet food product according to claim 23, which is a nutritionally balanced food product.

25. The pet food product according to claim 23, which is a loaf product in the form of a single piece of a reconstituted animal material, preferably having a piece volume of from about 20 to about 2,000 cm³.

26. The pet food product according to claim 23, which is a chunk-in-sauce product, preferably wherein the ratio of reconstituted animal material:sauce is from about 20:80 to about 90:10.

27. The pet food product according to claim 26, wherein the sauce exhibits a water content of at least about 80 wt % by total weight of the sauce, preferably wherein the sauce comprises a thickening agent selected from the group consisting of carrageenan, xanthan, guar gum, cassia gum, starch, gelatine and combinations thereof

28. The pet food product according to claim 23, wherein the pet food product comprises from about 5 wt % to about 100 wt % of the reconstituted animal material, by total weight of the pet food product.

29. A pet food product comprising or consisting essentially or consisting of a reconstituted animal material, wherein the reconstituted animal material comprises animal protein and a binder, wherein the binder comprises algal biomass and animal blood plasma.

30. A process for the preparation of reconstituted animal material comprising animal protein and a binder comprising algal biomass and animal blood plasma, the process comprising the steps of:
(i) mixing a ground animal material with a heat-settable binder comprising algal biomass and animal blood plasma;
(ii) preferably, preparing a slurry from the mixture and subjecting the slurry to conditions of shear to produce an emulsion of the mixture;
(iii) heating the mixture to an internal temperature of at least 70° C., preferably at least about 80° C., preferably wherein the duration of heating is at least 30 seconds; and
(iv) forming discrete pieces of reconstituted animal material.

31. A process for the preparation of a wet pet food product comprising reconstituted animal material wherein the reconstituted animal material comprises animal protein and a binder comprising algal biomass and animal blood plasma, the process comprising the steps of:
(i) mixing a ground animal material with a heat-settable binder comprising algal biomass and animal blood plasma;
(ii) preferably, preparing a slurry from the mixture and subjecting the slurry to conditions of shear to produce an emulsion of the mixture;
(iii) heating the mixture to an internal temperature of at least 70° C., preferably at least about 80° C., preferably wherein the duration of heating is at least 30 seconds;
(iv) forming discrete pieces of reconstituted animal material;
(v) optionally combining the reconstituted animal material with a sauce;
(vi) inserting the reconstituted animal material and optional sauce into a package; and
(vii) sealing and sterilizing the package to provide a packaged wet pet food product.

32. The process according to claim 30, wherein the slurry comprises ground animal material in an amount of from about 50 to about 99 wt % by weight of the slurry.

33. The process according to claim 30, wherein the heating of the mixture is conducted by heating from below by applying steam to an underside of a continuous belt carrying the mixture and/or from above by bringing steam into direct contact with the mixture.

34. (canceled)

35. (canceled)

36. The pet food product according to claim 23, wherein the pet food product is a wet pet food product.

37. The pet food product according to claim 29, wherein the pet food product is a dry pet food product.

38. The pet food product according to claim 29, wherein the pet food product is a semi-moist pet food product.
